(19) United States
(12) Patent Application Publication
(10) Pub. No.: US 2003/0225177 A1
(43) Pub. Date: Dec. 4, 2003

(54) Integral skin foams employing 1,1,1,3,3-pentafluoropropane as blowing agent

(76) Inventors: Peter Brian Logsdon, Orchard Park, NY (US); David John Williams, East Amherst, NY (US); Mary Charlotte Bogdan, West Seneca, NY (US); Kevin Donald Uhrich, Alden, NY (US)

Correspondence Address: Marie Collazo, Honeywell International Inc., P.O. Box 2245, 101 Columbia Road, Morristown, NJ, 07962, US

(21) Appl. No.: 10/355,766

(22) Filed: Jan. 31, 2003

Related U.S. Application Data
(63) Continuation of application No. 09/965,684, filed on Sep. 27, 2001, now abandoned.
Application No. 09/965,684 is a continuation of application No. 09/659,000, filed on Sep. 11, 2000, now abandoned.
(60) Provisional application No. 60/153,186, filed on Sep. 10, 1999.

(51) Int. Cl. C08G 18/00

(52) U.S. Cl. 521/155

(57) ABSTRACT

The invention relates to integral skin foams and in particular to integral skin foams that are prepared using 1,1,1,3,3-pentafluoropropane (HFA-245fa) alone or in combination with water as the blowing agent. The foams exhibit physical characteristics such as resistance to abrasion and cracking on flex comparable to conventional chlorinated fluorocarbon blown foams. The foams of the present invention are suitable for use in many applications including, for example, shoe soles.

### CROSS-REFERENCE TO RELATED APPLICATION

This application claims priority of U.S. Provisional Patent Application Serial No. 60/153,186 filed Sep. 10, 1999.

### FIELD OF THE INVENTION

The present invention relates to integral skin foams and a process for preparing such foams. More particularly, the invention relates to integral skin foams employing pentafluoropropane as the sole blowing agent or with water as a co-blowing agent.

### BACKGROUND OF THE INVENTION

Integral skin foams are well known to those skilled in the art of polyurethane foams. Such foams have a cellular interior and a higher density microcellular or non-cellular skin. In general, to prepare such foams an organic isocyanate is reacted with a substance having at least one isocyanate reactive group in the presence of a catalyst, blowing agent, and a variety of optional additives. The reaction is carried out in a mold where a higher density skin forms at the interface of the reaction mixture and the relatively cool inner surface of the foam.

Hydrochlorofluorocarbons have been banned from use in integral skin applications since Jan. 1, 1994 with the exception of automotive safety applications, which was granted an extension until Jan. 1, 1996. Other blowing agents such as water (CO₂), 1,1,1,2-tetrafluoroethane (HFC-134a) and hydrocarbons are currently being used with varying degrees of success. Water-based integral skin foams require higher foam densities and produce poor skin quality. HFC-134a has been added to these formulations to minimize pinholes associated with water blown foams. In some instances, water also requires the more expensive, pure MDI versus polymeric MDI (diphenylmethane diisocyanate).

Past methods of preparing integral skin polyurethanes with CFCs as a blowing agent include Great Britain Patent No. 1,209,297, which teaches the use of a combination blowing agent consisting of a CFC and a hydrate of an organic compound which splits off water at temperatures above 40° C. This blowing agent or combination of agents was used in a formulation with a suitable polyisocyanate, a polyol containing hydroxyl group and a catalyst. This patent discloses that free water in the system leads to a skin that is permeated with fine cells, which is undesirable.

Attempts have been made to evaluate the performance of alternate blowing agents to CFCs. In a paper by J. L. R. Clatty and S. J. Harasin entitled, Performance of Alternate Blowing Agents to Chlorofluorocarbons in RIM Structural and Elastomeric Polyurethane Foams, presented to the Annual Polyurethane Technical/Marketing Conference in October, 1989, the authors addressed the use of water as a blowing agent for integral skin polyurethane reaction injection molded systems (RIM). In this application, the water concentration in the system is controlled by the concentration and type of molecular sieves used. As in the Great Britain patent discussed previously, the water is not in a free form but bound in some manner. In this instance, the authors state that this process is limited to use in rigid foam systems; and the flexible integral skin formulations may best be served by using HCFCs or HCFC-22 as substitutes for CFCs.

A recently employed integral skin foam formulation is described in U.S. Pat. No. 5,100,922 to Wada et al. which relates to a method for producing a molded product of integral skin polyurethane foam. The method comprises reacting and curing (1) a high molecular weight polyol comprising, as the main component, a polyoxyalkylene polyol having, as the main constituent, oxyalkylene groups of at least 3 carbon atoms and oxyethylene groups at its molecular terminals with the overall oxyethylene group content being not higher than 15% by weight and having a hydroxyl value of not higher than 80; (2) a crosslinking agent containing a compound having an aromatic nucleus and at least two active hydrogen-containing groups selected from the group consisting of hydroxyl groups, primary amino groups and secondary amino groups; and (3) a polyisocyanate, in a mold in the presence of a catalyst and a hydrogen atom containing halogenated hydrocarbon foaming agent. While an extensive list of blowing agents are provided, the only pentafluoro-compounds described are chlorinated compounds such as 3,3-dichloro-1,1,1,2,2-pentafluoropropane and 1,3-dichloro-1,1,2,2,3-pentafluoropropane, which are considered undesirable.

U.S. Pat. No. 5,506,275 relates to the use of 1,1,1,2-tetrafluoroethane as an alternative to conventional chlorinated fluorocarbon blowing agents in integral skin foam formulations. While this patent offers an alternative to halogenated hydrocarbon blowing agents per se, 1,1,2-tetrafluoroethane (HFC-134a) boils at −26.5° C. and thus requires special gas delivery systems to introduce and maintain the blowing agent in solution, especially in warm weather conditions i.e. above 90° F. As such, still further improvements in the art are considered necessary.

It has been found that foams utilizing pentafluoropropane blowing agents, in particular 1,1,1,3,3-pentafluoropropane as the blowing agent alone or in combination with limited amounts of water, can be prepared which meet the stringent requirements inherent to integral skin foam applications such as acceptable appearance and enhanced resistance to abrasion and cracking upon flex.

The physical properties of integral skin foams prepared using 1,1,1,3,3-pentafluoropropane (HFC-245fa) are excellent and are comparable to CFC-11 based foams, especially in the areas of skin quality and thickness. Comparative work on CFC-11 produced some unexpected results. At the same weight percent loading of blowing agent in the B-side, the free rise density of HFC-245fa was approximately one-hale that of CFC-11 based foams even though HFC-245fa and CFC-11 have very similar molecular weights. This represents a potential cost savings for the producers of integral skin foams.

HFC-245fa has improved solubility in polyol pre-mixes versus HFC-134a, thus, HFC-245fa produces lower density foams, and at the same free rise density provides a skin 25 to 50 percent thicker than HFC-134a. HFC-245fa based integral skin foams also provide improved mechanical properties versus HFC-134a.

### SUMMARY OF THE INVENTION

The present invention relates to an integral skin polyurethane foam comprising the reaction product of:

a) a polyisocyanate; and

b) a polyol; in the presence of

c) a blowing agent comprising 1,1,1,3,3-pentafluoropropane and optionally water;

d) a catalyst; and

e) optionally one or more compounds selected from the group consisting of chain extenders, a surfactant, an alcohol having from 10 to 20 carbons, fillers, pigments, antioxidants, stabilizers and mixtures thereof.

The invention also relates to a method of making an integral skin polyurethane foam article comprising:

a) providing a polyisocyanate;

b) providing a B-side comprising:

i) a polyol

ii) a blowing agent comprising 1,1,1,3,3-pentafluoropropane and optionally water

iii) a catalyst; and

iv) optionally one or more compounds selected from the group consisting of chain extenders, a surfactant, an alcohol having from 10 to 20 carbons, fillers, pigments, antioxidants, stabilizers and mixtures thereof; and

c) introducing a) and b) into a mold and reacting the components for a period of time sufficient to produce an integral skin polyurethane article.

The invention further relates to an integral skin polyurethane article, for example, a shoe sole, obtained by the method of the invention.

### DETAILED DESCRIPTION

The organic polyisocyanates used in the instant process contain aromatically bound isocyanate groups. Representative of the types of organic polyisocyanates contemplated herein include, for example, 1,4-diisocyanatobenzene, 1,3-diisocyanato-o-xylene, 1,3-diisocyanato-p-xylene, 1,3-diisocyanato-m-xylene, 2,4-diisocyanato- 1-nitrobenzene, 2,5-diisocyanato-1-nitrobenzene, m-phenylene diisocyanate, 2,4-toluene diisocyanate, 2,6-toluene diisocyanate, mixtures of 2,4- and 2,6-toluene diisocyanate, 4,4′-biphenylmethane diisocyanate, 4,4′diphenylmethane diisocyanate, 3,3′-4,4′-diphenylmethane diisocyanate, and 3,3′-dimethyldiphenylmethane4,4′-diisocyanate; the triisocyanates such as 4,4′,4″-triphenylmethane triisocyanate, polymethylene polyphenylene polyisocyanate, and 2,4,6-toluene triisocyanate; and the tetraisocyanates such as 4,4-dimethyl-2,2′-5′-diphenylmethane tetraisocyanate. Especially useful due to their availability and properties are 2,4′-diphenylmethane diisocyanate, 4,4′-diphenylmethane diisocyanate, polymethylene polyphenylene polyisocyanate and mixtures thereof.

These polyisocyanates are prepared by conventional methods known in the art such as the phosgenation of the corresponding organic amine. Included within the usable isocyanates are the modifications of the above isocyanates which contain carbodiimide, allophanate, alkylene or isocyanurate structures. Quasi-prepolymers may also be employed in the process of the subject invention. These quasi-prepolymers are prepared by reacting an excess of organic polyisocyanate or mixtures thereof with a minor amount of an active hydrogen containing compound determined by the well known Zerewitinoff Test, as described by Kohler in Journal of the American Chemical Society, 49, 3181 (1927). These compounds and their methods of preparation are well known in the art. The use of any one specific active hydrogen compound is not critical hereto; rather, any such compound can be employed herein. Generally, the quasi-prepolymers have a free isocyanate content of from 20 percent to 40 percent by weight.

Mixtures of polymeric diphenylmethane diisocyanate (polymeric MDI) and carbodiimide or urethane modified MDI are preferred.

The isocyanate reactive composition, otherwise referred to herein as a polyol may include any suitable polyoxyalkylene polyether polyol such as those resulting from the polymerization of a polyhydric alcohol and an alkylene oxide. Representatives of such alcohols may include ethylene glycol, propylene glycol, trimethylene glycol, 1,2-butanediol, 1,3-butanediol, 1,4-butanediol, 1,2-pentanediol, 1,4-pentanediols, 1,5-pentanediol, 1,6-hexanediol, 1,7-heptanediol, glycerol, 1,1,1-trimethylolpropane, 1,1,1-trimethylololethane or 1,2,6-hexanetriol. Any suitable alkylene oxide may be used such as ethylene oxide, propylene oxide, butylene oxide, amylene oxide and mixtures of these oxides. The polyoxyalkylene polyether polyols may be prepared from other starting materials such as tetrahydrofuran and alkylene oxidetetrahydrofuran mixtures, epihalohydrins such as epichlorophydrin, as well as aralkylene oxides such as styrene oxide. The polyoxyalkylene polyether polyols may have either primary or secondary hydroxyl groups. Included among the polyether polyols are polyocyethylene glycol, polyoxypropylene glycol, polyoxybutylene glycol, polytetramethylene glycol, block copolymers, for example, combinations of polyoxypropylene and polyoxyethylene glycols, poly-1,2-oxybutylene and polyoxyethylene glycols and copolymer glycols prepared from blends or sequential addition of two or more alkylene oxides. The polyoxyalkylene polyether polyols may be prepared by any known process, such as the process disclosed by Wurtz in 1859 and Encyclopedia of Chemical Technology, Vol. 7, pp. 257-262, published by Interscience Publishers, Inc. (1951) or in U.S. Pat. No. 1,922,459.

Other polyoxyalkylene polyether polyols which may be employed are those which contain grafted therein vinylic monomers. The polyols which have incorporated therein the vinylic polymers may be prepared (1) by the in situ free radical polymerization of an ethylenically unsaturated monomer or mixture of monomers in a polyol, or (2) by dispersion in a polyol of a preformed graft polymer prepared by free radical polymerization in a solvent such as described in U.S. Pat. Nos. 3,931,092; 4,014,846; 4,093,573 and 4,122,056; the disclosures of which are herein incorporated by reference, or (3) by low temperature polymerization in the presence of chain transfer agents. These polymerizations may be carried out at a temperature between 65° C. and 170° C., preferably between 75° C. and 135° C. The amount of ethylenically unsaturated monomer employed in the polymerization reaction is generally from one percent to 60 percent, preferably from 10 percent to 40 percent, based on the total weight of the product. The polymerization occurs at a temperature between about 80° C. and 170° C., preferably from 75° C. to 135° C.

The polyols which may be employed in the preparation of the graft polymer dispersions are well known in the art. Both conventional polyols essentially free from ethylenic unsaturation such as those described in U.S. Pat. No. RE 28,715 and unsaturated polyols such as those described in U.S. Pat. No. 3,652,659 and RE 29,014 may be employed in preparing the graft polymer dispersions used in the instant invention, the disclosures of which are incorporated by reference.

Representative polyols essentially free from ethylenic unsaturation which may be employed are well known in the art. They are often prepared by the catalytic condensation of an alkylene oxide or mixture of alkylene oxides either simultaneously or sequentially with an organic compound having at least two active hydrogen atoms such as evidenced by U.S. Pat. Nos. 1,922,459; 3,190,927 and 3,346,557, the disclosures of which are incorporated by reference.

The unsaturated polyols which may be employed for preparation of graft copolymer dispersions may be prepared by the reaction of any conventional polyol such as those described above with an organic compound having both ethylenic unsaturation and a hydroxyl, carboxyl, anhydride, isocyanate, or epoxy group; or they may be prepared by employing an organic compound having both ethylenic unsaturation and a hydroxyl, carboxyl, anhydride, or epoxy group as a reactant in the preparation of the conventional polyol. Representative of such organic compounds include unsaturated mono- and polycarboxylic acids and anhydrides such a maleic acid and anhydride, fumaric acid, crotonic acid and anhydride, propenyl succinic anhydride, and halogenated maleic acids and anhydrides, unsaturated polyhydric alcohols such as 2-butene-1,4-diol, glycerol allyl ether, trimethylopropane allyl ether, pentaerythritol allyl ether, pentaerythritol vinyl ether, pentaerythritol diallyl ether, and 1-butene-3,4-diol, unsaturated epoxides such as 1-vinycyclohexene monoxide, butadiene monoxide, vinyl glycidyl ether, glycidyl methacrylate and 3-allyloxypropylene oxide.

As mentioned above, the graft polymer dispersions used in the invention are prepared by the in situ polymerization of an ethylenically unsaturated monomer or a mixture of ethylenically unsaturated monomer or a mixture of ethylenically unsaturated monomers, either in a solvent or in the above-described polyols. Representative ethylenically unsaturated monomers which may be-employed in the present invention include butadiene, isoprene, 1,4-pentadiene, 1,5-hexadiene, 1,7-octadiene, styrene, α-methylstyrene, methylstyrene, 2,4-dimethylstyrene, ethylstyrene, isopropylstyrene, butylstyrene, phenylstyrene, cyclohexylstyrene, benzylstyrene, and the like; substituted styrenes such as chlorostyrene, 2,5-dichlorostyrene, bromostyrene, fluorostyrene, trifluoromethylstyrene, iodostyrene, cyanostyrene, nitrostyrene, N,N-dimethylaminostyrene, acetoxystyrene, methyl4-vinylbenzoate, phenoxystyrene, p-vinyidiphenyl sulfide, p-vinylphenyl phenyloxide, and the like; the acrylic and substituted acrylic monomers such as acrylonitrile, acrylic acid, methacrylic acid, methylacrylate, 2-hydroxyethyl acrylate, 2-hydroxyethyl methacrylate, methyl methactylate, cyclohexyl methacrylate, benzyl methacrylate, isopropyl methacrylate, octyl methacrylate, methacrylonitrile, methyl α-chloroacrylate, ethyl α-ethoxyacrylate, methyl α-acetam, inoacrylate, butyl acrylate, 2-ethylhexyl acrylate, phenyl acrylate, phenyl methacrylate, α-chloroacrylonitrile, methacrylonitrile, N,N-dimethylacrylamide, N,N-dibenzylacrylaminde, N-butylacrylamide, methacryl formamide and the like; the vinyl esters, vinyl ethers, vinyl ketones, etc., such as vinyl acetate, vinyl chloroacetate, vinyl alcohol, vinyl butyrate, isopropenyl acetate, vinyl formate, vinyl butyrate, isopropenyl acetate, vinyl formate vinyl methacrylate, vinyl methoxyacetate, vinyl benzoate, vinyl iodide, vinyltoluene, vinylnaphthalene, vinyl bromide, vinyl fluoride, vinylidene bromide, 1-chloro-1-fluoroethylene, vinylidene fluoride, vinyl methyl ether, vinyl other, vinyl propyl ether, vinyl butyl ether, vinyl 2-ethylbexyl ether, vinyl phenyl ether, vinyl 2-butoxyethyl ether, 2,4-dihydro-1,2-pyran, 2-butoxy-2′-vinyloxy diethyl ether, vinyl 2-ethylthioethyl ether, vinyl methyl ketone, vinyl ethyl ketone, vinyl phenyl ketone, vinyl phosphonates such as bis(β-chloroethyl)vinyl phosphonate, vinyl ethyl sulfide, vinyl ethyl sulfone, N-methyl-N-vinyl acetamide, N-vinyl pyrrolidene, vinyl imidazole, divinyl sulfide, divinyl sulfoxide, divinyl sulfone, sodium vinylsulfonate, methyl vinylsulfonate, N-vinyl pyrrole, and the like; dimethyl fumarate, dimethyl maleate, maleic acid, crotonic acid, fumaric acid, itaconic acid, monomethyl itaconate, butylaminoethyl methacrylate, dimethylaminoethyl methacrylate, glycidyl acrylate, allyl alcohol, glycol monoesters of itacotric acid, dichlorbutadiene, vinyl pyridine, and the like. Any of the known polymerizable monomers can be used, and the compounds listed above are illustrative and not restrictive of the monomers suitable for use in this invention. Preferably, the monomer is selected from the group consisting of acrylonitrile, styrene, methyl methacrylate, and mixtures thereof.

The total amount of polyol employed in accordance with the teachings of the present invention includes from about 60 pbw to about 150 pbw based on a total of 150 parts by weight (pbw) for the B-side and a foam index of between about 95-110.

Illustrative initiators which may be employed for the polymerization of vinyl monomers are the well known free radical types of vinyl polymerization initiators, for example, the peroxides, persulfates, perborates, percarbonates, azo compounds, etc. including hydrogen peroxide, dibenzoyl peroxide, acetyl peroxide, benzoyl hydroperoxide, t-butyl hydroperoxide, di-t-butyl peroxide, lauroyl peroxide, butyryl peroxide, diisopropylbenzene hydroperoxide, cumeme hydroperoxide, paramenthane hydroperoxide, di-α-cumyl-peroxide, dipropyl peroxide, diisopropyl peroxide, difuroyl peroxide, ditriphenylmethyl peroxide, bis(p-methoxybenzoyl) peroxide, p-monoethoxybenzoyl peroxide, rubene peroxide, ascaridol, t-butyl peroxybenzoate, diethyl peroxyterephthalate, propyl hydroperoxide, isopropyl hydroperoxide, n-butyl hydroperoxide, cyclohexyl hydroperoxide, trans-decalin hydroperoxide, α-methylbenzyl hydroperoxide, α-methyl-α-ethyl benzyl hydroperoxide, tetralin hydroperoxide, triphenylmethyl hydroperoxide, diphenylmethyl hydroperoxide, α,α′-azobis(2methyl)heptonitrile,1,1-azo-bis(1-cyclohexane)carbonitrile, dimethyl α,α′-azobis(isobutyroitrile), 4,4-′azobis(cyanopetanoic) acid, azobis(isobutyronitrile), 1-t-amylazo-1-cyanocyclohexane, 2-t-butylazo-2-cyano-4-methoxy4-methylpentane, 2-t-butylazo-2-cyano-4-methylpentane, 2-(t-butylazo)isobutyronitrile, 2-t-butylazo-2cyanobutane, 1-cyano-l-(t-butylazo)cyclohexane, t-butyl peroxy-2-ethylhexanoate, t-butyl perpivalate, 2,5-dimethylhexane-2,5-diper-2-ethylhexoate, t-butylperneo-decanoate, t-butyl perbenzoate, t-butyl percroloate, persuccinic acid, diisopropyl peroxydicarbonate and the like; a mixture of initiators may also be used. Photochemically sensitive radical generators may also be employed. Generally from about 0.5 percent to about 10 percent, preferably from about 1 percent to about 4 percent, by weight of initiator based on the weight of the monomer will be employed in the final polymerization.

Stabilizers may be employed during the process of making the graft polymer dispersions. One such example is the stabilizer disclosed in U.S. Pat. No. 4,148,840, which comprises a copolymer having a first portion composed on an ethylenically unsaturated monomer or mixture of such monomers and a second portio which is a propylene oxide polymer. Other stabilizers which may be employed are the alkylene oxide adducts of copolymers of styrene-allyl alcohol.

The preferred polyols are polyethers having an average functionality of about 1.75 to about 3.0 and a molecular weight range of from about 3500 to about 5100. The most preferred polyols are polyethers which are copolymers of ethylene oxide and propylene glycol glycerine or trimethylolpropane. Include with this group are the previously described graft polymer dispersions.

Any suitable catalyst may be used including tertiary amines such as triethylenediamine, N-methylmorpholine, N-ethylmorpholine, diethylethanolamine, N-cocomorpholine, 1-methyl4-dimethylaminoethylpiperazine, methoxypropyidimethylamine, N,N,N-trimethylisopryl propylenediamine, 3-diethylaminopropyldiethylamine, dimethylbenzylamine and the like. Other suitable catalysts are, for example, dibutylin dilaurate, dibutyltin d/acetate, stannous chloride, dibutyltin di-2-ethyl hexanoate, stannous oxide, available under the FOMREZ® trademark, as well as other organometallic compounds such as are disclosed in U.S. Pat. No. 2,846,408.

An alcohol having from about 10 to about 20 carbons or mixtures thereof may be used in the present invention. Alcohols of this type are known to those skilled in the art. The types of alcohols contemplated are commonly produced via the oxo process and are referred to as oxo-alcohols. Examples of some commercially available products include LIAL 125 from Chemica Augusta Spa or NEODOL® 25 produced by Shell. Such alcohols are known for enhancing cross-linking, thereby improving tear resistance.

While surface active agents are generally not needed to solubilize the blowing agent of the present invention, in contrast to other known blowing agents, surface active agents, i.e., surfactants, may be employed, for example, to regulate the size cell size and structure of the resulting foams. Typical examples of such surface active agents include siloxane oxyalkylene heterol polymers and other organic polysiloxanes, oxyethylated alkyl phenol, oxyethylated fatty alcohols, fluoroaliphatic polymeric esters, paraffin oils, castor oil ester, phthalic acid esters, ricindolic acid ester, and Turkey red oil, as well as cell regulators such as paraffins.

Chain extending agents that may be employed in the present invention include those having two functional groups bearing active hydrogen atoms. A preferred group of chain extending agents includes ethylene glycol, diethylene glycol, propylene glycol, dipropylene glycol, or 1,4-butanediol and mixtures thereof.

Additives which may be used in the process of the present invention include anti-oxidants, known pigments, such as carbon black, dyes and flame retarding agents (e.g., tris-chloroethyl phosphates or ammonium phosphate and polyphosphate), stabilizers against aging and weathering, plasticizers, such as gamma butylactone, fungistatic and bacteriostatic substances and fillers.

The blowing agent of the present invention comprises 1,1,1,3,3-pentafluoropropane (HFC-245fa), which may be prepared by the fluorination of pentachloropropane with hydrogen fluoride in the presence of a catalyst as disclosed in U.S. Pat. No. 5,574,192. The HFC-245fa blowing agent is used either alone or in conjunction with water in amounts sufficient to provide the desired foam density. Depending upon the amount of water employed as a co-blowing agent and the pack factor of the molded component, the amount of HFC-245fa employed will generally range from about 0.5 weight percent to about 15 weight, and preferably from about 1.0 to about 8.0 weight percent based on the B-side for foams having molded densities of from about 2 to about 40 pcf. By way of non-limiting example, the amount of HFC-245fa used as the sole blowing agent for a shoe sole or the like will generally range from about 1.5 to about 5.0 weight percent for foams having molded densities of from 25 pcf to about 35 pcf at a molded pack factor of 1.5-3.0. By way of further example, the amount of pentafluoropropane used as a sole blowing agent for a steering wheel will generally range from about 2.0 to about 8.0 weight percent for foams having molded densities of from 25 to about 35 pcf with a pack factor of 2.0-6.0. As water is added as a co-blowing agent, the amount of HFC-245fa is proportionately reduced. In general, up, to about 2 weight percent of water may be employed as a co-blowing agent, preferably from about 0.01 to about 1.0 weight percent based on the B-side.

The mechanical parameters of the instant process are flexible and depend on the final application of the integral skin polyurethane foam. The reaction system is versatile enough that it may be made in a variety of densities and hardnesses. The system may be introduced into a mold in a variety of ways known to those skilled in the art It may be shot into a preheated closed mold via high pressure injection technique. In this manner, it processes well enough to fill complex molds at low mold densities (from 19 pcf to 25 pcf). It may also be run using a conventional open mold technique wherein the reaction mixture or system is poured or injected relatively at low pressure or atmospheric pressure into a preheated open mold. In the instant process, the system may be run at mold temperatures from about room temperature to about 120° F. with room temperature being preferred.

Having thus described the invention, the following examples are given by way of illustration with all amounts being given in parts by weight unless otherwise indicated.

### EXAMPLES

The same general procedure commonly referred to as “handmixing” is used to prepare all foams. For each blowing agent, a master batch of the premix combining all the components except blowing agent was prepared. About 2 kg is blended to insure that all of the foams in a given series are made with the same master batch of premix. The premix is blended in a one-gallon paint can, and stirred at about 1500 rpm with a Conn 2″ diameter ITC mixer until a homogenous blend was achieved. When mixing is complete the material is transferred to a one-gallon glass bottle and sealed. The bottle was then placed in a refrigerator controlled at 50° F. The foam blowing agents were kept separately in the same refrigerator, along with the 32 oz. tin cans used for mixing vessels. The A-component, isocyanate, is kept in sealed containers at 70° F. For the individual foam preparations, an amount of B-component equal to the formulation weight is weighted into a 32 oz. tin can preconditioned at 50° F. The required amounts of the individual blowing agents, also preconditioned to 50° F. is added to the B-component. The contents are stirred for two-minutes with a Conn 2″ ITC mixing blade turning at about 1000 rpm. Following this, the mixing vessel and contents are reweighed. If there is a weight loss, the lower boiling blowing agent is added to make up the loss. The contents are then stirred for an additional 30 seconds, and the can replaced in the refrigerator.

After the contents have cooled again to 50° F., approximately 10 minutes, the mixing vessel is removed from the refrigerator and taken to the mixing station. A pre-weighed portion of A-component, isocyanate, is added quickly to the B□component, the ingredients mixed for 10 seconds using a Conn 2″ diameter ITC mixing blade at 3000 rpm and poured into a 8″×8×4″ cardboard cake box and allowed to rise. Cream, initiation, gel and tack free times were recorded for the individual polyurethane foam samples.

The foams are allowed to cure in the boxes at room temperature for at least 24 hours. After curing, the blocks are trimmed to a uniform size and the densities are measured Any foam that did not meet the density specification are discarded, and new foams prepared using an adjusted amount of blowing agent in the formulation to obtain the specified density.

For test purposes both molded and free rise foam samples were prepared. The necessary quantity of B-side required to obtain the targeted molded density were calculated. The foam components were weighed so that the final total weight is equal to the weight needed in the mold allowing for what ever hang up was present in the mixing vessel. After mixing the foam components per the above described procedure the foam was poured into a 6″×6″×1″ heated to 98° F. which has been lightly sprayed with silicone mold release. After 4 minutes, the plaque was demolded and trimmed. The net weight of the plaques was taken and the foam density calculated. After 24 hours curing time, physical properties were tested.

The reactivity profiles and free rise densities for HFC-245fa and CFC-11 are reported in Tables I and II, respectively. HFC-245fa was evaluated at 50° F. for both the A- and B-sides in order to minimize evaporation of HFC-245fa and frothing of the B-side. Attempts were made to run CFC-11 evaluation at 50° F. for the A- and B-sides. However, the reactivity was extremely slow and produced poor quality foam. Thus CFC-11 was evaluated at 70° F. The free rise density of HFC-245fa at 20 wt. % could not be determined since the cells were very coarse and the foam collapsed

TABLE I
Free Rise Data for HFC-245fa (T_{A} = T_{B} = 50° F.)

| Example | FR-1 | FR-2 | FR-3 | FR-4 |
|---|---|---|---|---|
| Polyol Premix (g) | 100.14 | 84.52 | 63.04 | 60.00 |
| HFC-245fa (g) | 5.32 | 9.41 | 11.17 | 14.98 |
| Wt. % HFC-245fa | 5 | 10 | 15 | 20 |
| ISO (g) | 46.8 | 41.0 | 28.8 | 27.0 |
| Mix Time (sec) | 10 | 10 | 10 | 10 |
| Cream Time (sec) | 42 | 38 | 35 | 34 |
| Gel Time (sec) | 70 | 80 | 90 | 108 |
| Rise Time (sec) | 28 | 52 | 53 | 74 |
| Tack Free Time (sec) | 93 | 106 | 118 | 173 |
| Foam Weight (g) | 83.7 | 47.2 | 31.8 | — |
| Foam Volume (cc) | 500 | 500 | 500 | — |
| Overall Density (pcf) | 10.43 | 5.88 | 3.96 | — |

TABLE II
Free Rise Data for CFC-11 (T_{A} = T_{B} = 70° F.)

| Example | FR-5 | FR-6 | FR-7 | FR-8 |
|---|---|---|---|---|
| Polyol Premix (g) | 100 | 84.5 | 63 | 60 |
| CFC-11 (g) | 5.3 | 9.4 | 11.1 | 15 |
| Wt. % CFC-11 | 5 | 10 | 15 | 20 |
| ISO (g) | 46 | 39 | 28.2 | 27.0 |
| Mix Time (sec) | 10 | 10 | 10 | 10 |
| Cream Time (sec) | — | 38 | 37 | 37 |
| Gel Time (sec) | 50 | 55 | 65 | 65 |
| Rise Time (sec)* | — | — | — | — |
| Tack Free Time (sec) | 70 | 73 | 82 | 90 |
| Foam Weight (g) | 81.2 | 69.2 | 54.0 | 39.7 |
| Foam Volume (cc) | 250 | 400 | 500 | 500 |
| Overall Density (pcf) | 20.3 | 10.8 | 6.7 | 5.0 |

*Not measured.

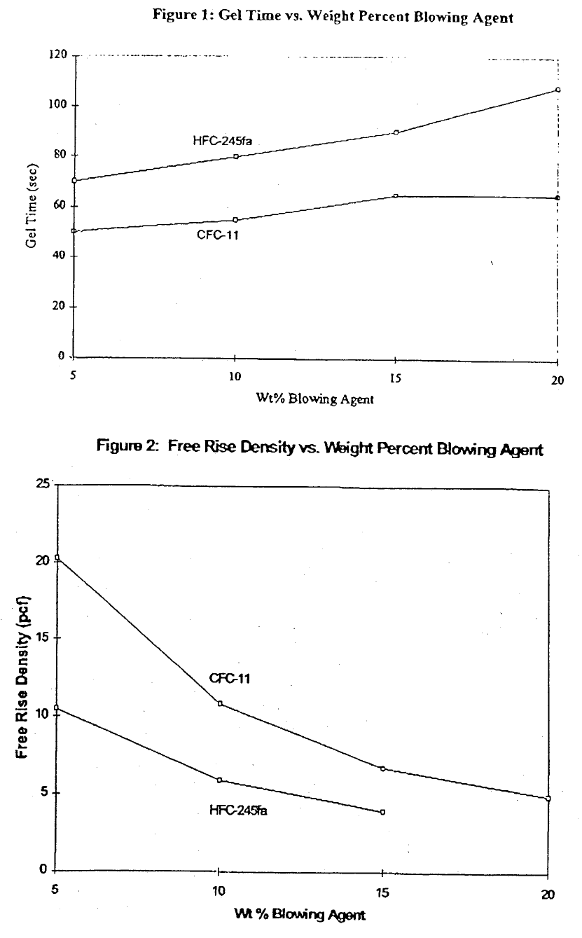

FIG. 1 shows the gel time as a function of blowing agent concentration for both HFC-245fa and CFC-11. As expected, the gel times for the HFC-245fa formulation were longer than for the CFC-11 formulation. This can be attributed to two factors: the lower boiling point of HFC-245fa and the lower processing temperature (50° F.).

The free rise density was plotted versus blowing agent concentration for both blowing agents evaluated. These results are shown in FIG. 2. Noted here is the substantial reduction in free rise density for HFC-245fa foam versus CFC-11 blown foam, particularly at low blowing agent weight percent. For example, at 5 wt. % blowing agent, the density of the HFC-245fa foam is nearly one-half that of CFC-11 foam. This cannot be attributed to the molecular weight difference of the two blowing agents (134 g/mole for HFC-245fa vs. 137.4 g/mole for CFC-11). One explanation may be the difference in the processing temperatures used in the study. The lower temperature for HFC-245fa used during processing produces a longer gel time. This means that the foam would rise for a longer period of time before it gels. The rise time was not measured for the CFC-11 free rise study.

The results for the poured foam samples of HFC-245fa and CFC-11 are given in Table III and IV. A 6″×6″×1″ mold was used for these samples. The typical mold temperature was 98° F. As in the free rise density work, HFC-245fa foams were prepared at 50° F. for both the A- and B-sides while the CFC-11 foams were prepared at 70° F.

The molded foam at 30 pcf and 15 and 20 wt. % HFC-245fa could not be formed since the force of the rising foam caused the foam to squeeze out of the mold. This can be attributed to the density difference between the formulations. Just pouring the required mass of the HFC-245fa formulation in the mold to achieve 30 pcf would almost fill the mold prior to reaction and subsequent expansion. This was no the case for CFC-11 foams.

TABLE III
Molded Foam Data for HFC-245fa
(T_{A} = T_{B} = 50° F.; Mold T = 98° F.)

| Example | Mold-1 | Mold-2 | Mold-3 | Mold-4 | Mold-5 | Mold-6 |
|---|---|---|---|---|---|---|
| Molded Density Target | 20 | 20 | 20 | 20 | 30 | 30 |
| (pcf) | | | | | | |
| Wt. % HFC-245fa | 5 | 10 | 15 | 20 | 5 | 10 |
| Polyol Premix (g) | 165 | 160 | 155 | 150 | 215 | 205 |
| ISO (g) | 75.7 | 73.0 | 31.0 | 68.0 | 96.0 | 90.4 |
| Target Weight (g) | 189 | 189 | 189 | 189 | 284 | 284 |
| Foam Weight (g) | 188.9 | 189.3 | 184.6 | 178.3 | 286.1 | 276.1 |
| Overall Density (pcf) | 20.0 | 20.0 | 19.5 | 18.9 | 30.2 | 29.2 |

TABLE IV
Molded Foam Data for CFC-11 (T_{A} = T_{B} = 70° F.; Mold T = 98° F.)

| Example | Mold-9 | Mold-10 | Mold-11 | Mold-12 | Mold-13 | Mold-14 | Mold-15 | Mold-16 |
|---|---|---|---|---|---|---|---|---|
| Molded | 20 | 20 | 20 | 20 | 30 | 30 | 30 | 30 |
| Density | | | | | | | | |
| Target (pcf) | | | | | | | | |
| HFC-245fa | 5 | 10 | 15 | 20 | 5 | 10 | 15 | 20 |
| (wt. %) | | | | | | | | |
| Polyol | 165.2 | 160.1 | 155.2 | 150 | 215.2 | 205 | 195 | 190 |
| ISO (g) | 74.7 | 71.2 | 71.0 | 68.7 | 97.0 | 94.6 | 89.4 | 85.2 |
| Target | 191.4 | 188.4 | 192.0 | 181.6 | 280.8 | 279.8 | 282.6 | 280.1 |
| Weight (g) | | | | | | | | |
| Foam | 191.4 | 188.4 | 192.0 | 181.6 | 280.8 | 279.8 | 282.6 | 280.1 |
| Weight (g) | | | | | | | | |
| Overall | 20.2 | 19.9 | 20.3 | 19.2 | 29.6 | 29.6 | 29.9 | 29.6 |
| Density (pcf) | | | | | | | | |

TABLE V
Physical Property Comparison of Foams Blown with
CFC-11, H₂O and HFC-245fa

| | | | | | HFC- |
|---|---|---|---|---|---|
| Index = 100 | CFC-11 | H₂O | | | 245fa |
| Hand mix free rise density (pcf) | 3.5 | 8.5 | | | 3.5 |
| Molded Density (pcf) | 7.0 | 15 | 20 | 25 | 7.0 |
| Core Tensile Strength (psi) | 838 | 180 | 250 | 375 | 895 |
| Core Elongation (%) | 95 | 180 | 190 | 180 | 110 |
| Trouser Tear Strength (pli) | 102 | 48 | 66 | 95 | 131 |

TABLE VI
Comparison of Physical and Mechanical Properties of Foam Samples
Made Using HFC-134a and HFC-245fa for a Polyether Polyol System

| | HFC-134a | HFC-134a | HFC-245fa | HFC-245fa |
|---|---|---|---|---|
| Ratio (R/A) | 100/50.5 | 100/51.8 | 100/50.5 | 100/51.9 |
| Index | 95 | 97 | 97 | 100 |
| Density (pcf) | 38.7 | 37.4 | 36.8 | 38.0 |
| Shore A | 65 | 63 | 63 | 65 |
| Tensile Strength @ Break (psi) | 642 | 620 | 618 | 772 |
| Elongation @ Break (%) | 505 | 430 | 525 | 560 |
| Trouser Tear (pli) | 46 | 38 | 40 | 35 |

TABLE VII
Aging Study on HFC-245fa in Medium Density Polyether Polyol System
Closed Container Vapor Sapce Above Polyol˜60% (Stored at Room
Temperature)

| Aging Study | Initial | 21 Days |
|---|---|---|
| Polyol weight (g) | 230 | 230 |
| Isocyanate weight (g) | 118 | 118 |
| Cream time (sec) | 15 | 16 |
| Rise Time (sec) | 35 | 35 |
| Gel Time (see) | 46 | 57 |
| Tack Free Time (sec) | 70 | 75 |
| Indent Recovery Time (sec) | 125 | 130 |
| Cup Density (pcf) | 18.6 | 19.8 |

While it will be apparent that the preferred embodiments of the invention disclosed are well calculated to fulfill the objects stated, it will be appreciated that the invention is susceptible to modification, variation and change without departing from the spirit thereof

What is claimed is:

1. An integral skin polyurethane foam comprising the reaction product of:
a) a polyisocyanate; and
b) a polyol; in the presence of
c) a blowing agent comprising 1,1,1,3,3-pentafluoropropane and optionally water,
d) a catalyst; and
e) optionally one or more compounds selected from the group consisting of chain extenders, a surfactant, an alcohol having from 10 to 20 carbon atoms, fillers, pigments, antioxidants, stabilizers and mixtures thereof

2. An integral skin foam as recited in claim 1 wherein the blowing agent is present in an amount of from about 0.5 to about 15 weight percent based on the total weight of b)-e).

3. An integral skin foam as recited in claim 1 wherein the blowing agent is present in an amount of from about 1.0 to about 8 weight percent based on the total weight of b)-e).

4. An integral skin foam as recited in claim 1 wherein the blowing agent includes water in an amount of up to about 2.0 weight percent based on the total weight of b)-e).

5. An integral skin foam as recited in claim 1 wherein the water is present in an amount of from about 0.01 to about 1.0 weight percent based on the total weight of b)-e).

6. A method for producing an integral skin polyurethane article comprising:
a) providing a polyisocyanate;
b) providing a B-side comprising:
i) a polyol;
ii) a blowing agent comprising 1,1,1,3,3-pentafluoropropane and optionally water;
iii) a catalyst; and
iv) optionally one or more compounds selected from the group consisting of chain extenders, a surfactant, an alcohol having from 10 to 20 carbons, fillers, pigments, antioxidants, stabilizers and mixtures thereof; and
c) introducing a) and b) into a mold and reacting for a period of time sufficient to produce a molded integral skin polyurethane article.

7. A method as recited in claim 6 wherein the blowing agent is present in an amount of from about 0.5 to about 15 weight percent based on the total weight of b)-e).

8. A method as recited in claim 6 wherein the blowing agent is present in an amount of from about 1.0 to about 8.0 weight percent based on the total weight of b)-e).

9. A method as recited in claim 6 wherein the blowing agent consists essentially of 1,1,1,3,3-pentafluoropropane.

10. A method as recited in claim 6 wherein the blowing agent comprises water in an amount of from about 0.01 to about 1.0 weight percent based on the total weight of b)-e).

11. A molded integral skin polyurethane article having enhanced flexibility and abrasion resistance which is obtained by:
a) providing a polyisocyanate;
b) providing a B-side comprising:
i) a polyol;
ii) a blowing agent comprising 1,1,1,3,3-pentafluoropropane and optionally water;
iii) a catalyst; and
iv) optionally one or more compounds selected from the group consisting of chain extenders, a surfactant, an alcohol having from 10 to 20 carbons, fillers, pigments, antioxidants, stabilizers and mixtures thereof; and
c) introducing a) and b) into a mold and reacting for a period of time sufficient to produce a molded integral skin polyurethane article.

12. An integral skin polyurethane article as recited in claim 11 wherein said blowing agent is present in an amount of from about 0.5 to about 15 weight percent based on the total weight of b)-e).

13. An integral skin polyurethane article as recited in claim 11 wherein said blowing agent is present in an amount of from about 1.0 to about 8 weight percent based on the total weight of b)-e).

14. An integral skin polyurethane article as recited in claim 11 wherein said blowing agent consists essentially of 1,1,1,3,3-pentafluoropropane.

15. An integral skin polyurethane article as recited in claim 11 wherein the blowing agent comprises water in an amount of from about 0.01 to about 1.0 weight percent based on the total weight of b)-e).

16. The article of claim 11 wherein said article is a shoe sole.
